(19) United States
(12) Patent Application Publication
(10) Pub. No.: US 2022/0367936 A1
(43) Pub. Date: Nov. 17, 2022

(54) POWER SOURCE DEVICE, ELECTRIC VEHICLE EQUIPPED WITH SAID POWER SOURCE DEVICE, AND POWER STORAGE DEVICE

(71) Applicant: SANYO Electric Co., Ltd., Osaka (JP)

(72) Inventors: KAZUHIRO HARAZUKA, Hyogo (JP); GO YAMASHIRO, Hyogo (JP)

(21) Appl. No.: 17/620,165

(22) PCT Filed: Jun. 15, 2020
(86) PCT No.: PCT/JP2020/023449

§ 371 Date: Dec. 17, 2021

(30) Foreign Application Priority Data
Jun. 28, 2019 (JP) 2019-122486

(51) Int. Cl. H01M 10/658; H01M 50/209; H01M 50/264; H01M 50/431; H01M 50/293

(52) U.S. Cl. CPC H01M 10/658; H01M 50/209; H01M 50/264; H01M 50/431; H01M 50/293; H01M 2220/20; H01M 10/625

(57) ABSTRACT

A power source device includes: a plurality of battery cells each including exterior can formed in a rectangular shape and including opposing main surfaces; insulating heat-shrinkable films covering the plurality of battery cells, respectively; a plurality of separators interposed between the plurality of battery cells; a battery stack formed by stacking the plurality of battery cells with separators interposed therebetween; a pair of end plates disposed on both end surfaces of the battery stack; and a plurality of bind bars disposed on each of opposing side surfaces of the battery stack and fastening the end plates to each other, wherein heat-shrinkable films have expandability in which a maximum expansion amount in a heat-shrunk state is larger than a maximum expansion amount of main surfaces of exterior can at the time of expansion of battery cells.

### TECHNICAL FIELD

The present invention relates to a power source device with a large number of battery cells stacked, and an electric vehicle and a power storage device equipped with the power source device.

### BACKGROUND ART

A power source device including a large number of stacked battery cells is used for a power source device for driving an electric vehicle, a power source device for power storage, and the like. In such a power source device, a plurality of chargeable and dischargeable battery cells are stacked, and insulating separators are interposed between the battery cells. A configuration for insulating a surface of a battery cell is known in which the surface except an upper surface provided with an electrode terminal is covered with a thin heat-shrinkable film (for example, PTL 1).

Battery cells expand by charging and discharging. With the recent demand for higher capacity of the battery cells, an amount of expansion of each cell has become greater. Due to such expansion and contraction, an excessive stress is applied to the thin heat-shrinkable film. As described above, the heat-shrinkable film may be broken due to the deformation of the battery cell that repeats expansion and contraction. In particular, a heat-shrunk heat-shrinkable film is likely to be broken due to deformation of the battery cell that repeats expansion and contraction since the maximum expansion amount of the heat-shrinkable film that is stretched without being broken is reduced.

Meanwhile, for higher output and capacity required of power source devices, the number by which battery cells are stacked is growing, and a higher heat insulating performance has been required of the separators to avoid the heat of a battery cell affecting other battery cells. As a separator having a high heat insulating property, a separator using a heat insulating material composed of an inorganic powder and a fiber base material has been developed. As such a separator, for example, a separator in which silica aerogel having an extremely low thermal conductivity of 0.02 W/m·K is filled in gaps in a fiber sheet is employed, manifesting excellent heat insulation characteristics.

This heat insulating material has an excellent heat insulating property but has poor expandability, and thus does not expand and contract along with the expansion and contraction of the battery cell. Therefore, when the heat-shrinkable film is broken by repeating expansion and contraction of the battery cell, a stress also acts in a breaking direction on the heat insulating material bonded to the heat-shrinkable film. In particular, as shown in FIG. 10, when battery cell 101 repeats expansion and contraction in a state where heat-shrinkable film 5 is broken, a broken portion of heat-shrinkable film 105 is gradually widened, and as a result, a larger stress may act on heat insulating material 102 bonded to broken heat-shrinkable film 105 to cause cracking or breakage.

### CITATION LIST

### Patent Literature

PTL 1: Unexamined Japanese Patent Publication No. 2011-222198

### SUMMARY OF THE INVENTION

### Technical Problem

An object of the present invention is to provide a technique of protecting a heat-shrinkable film covering a battery cell when the battery cell is used under a condition where the battery cell is subjected to repeated expansion and contraction.

### Solution to Problem

A power source device according to an aspect of the present invention is a power source device including: a plurality of battery cells 1 each including exterior can 11 formed in a rectangular shape and including opposing main surfaces 1A; insulating heat-shrinkable films 5 covering the plurality of battery cells 1, respectively; a plurality of separators 2 interposed between the plurality of battery cells 1; battery stack 10 formed by stacking the plurality of battery cells 1 with separators 2 interposed therebetween; a pair of end plates 3 disposed on both end surfaces of battery stack 10; and a plurality of bind bars 4 disposed on each of opposing side surfaces of battery stack 10 and fastening end plates 3 to each other, wherein heat-shrinkable films 5 have expandability in which a maximum expansion amount in a heat-shrunk state is larger than a maximum expansion amount of main surfaces 1A of exterior can 11 at the time of expansion of battery cells 1.

An electric vehicle according to an aspect of the present invention includes power source device 100 described above, travel motor 93 to which electric power is supplied from power source device 100, vehicle body 91 on which power source device 100 and motor 93 are mounted, and wheels 97 driven by motor 93 to cause vehicle body 91 to travel.

A power storage device according to an aspect of the present invention includes power source device 100 described above, and power supply controller 88 that controls charging and discharging of power source device 100, and power supply controller 88 enables charging of battery cells 1 by electric power from an outside and performs control to charge battery cells 1.

### Advantageous Effect of Invention

A power source device described above can protect the heat-shrinkable film covering the battery cells when the battery cells are used under a condition where the battery cells are subjected to repeated expansion and contraction.

### BRIEF DESCRIPTION OF DRAWINGS

FIG. 1 is a perspective view of a power source device according to an exemplary embodiment of the present invention.

FIG. 2 is a vertical sectional view of the power source device illustrated in FIG. 1.

FIG. 3 is a horizontal sectional view of the power source device illustrated in FIG. 1.

FIG. 4 is an exploded perspective view illustrating a stacked state of a battery cell and a separator.

FIG. 5 is a schematic sectional view illustrating a stacked state of battery cells and a separator.

FIG. 6 is a schematic cross-sectional view illustrating a state in which battery cells are expanded in FIG. 5.

FIG. 7 is a block diagram illustrating an example in which a power source device is mounted on a hybrid vehicle that travels by an engine and a motor.

FIG. 8 is a block diagram illustrating an example in which a power source device is mounted on an electric vehicle that travels only by a motor.

FIG. 9 is a block diagram illustrating an example which applies to a power source device for power storage.

FIG. 10 is a schematic cross-sectional view illustrating a stacked state of conventional separator and battery cells.

### DESCRIPTION OF EMBODIMENTS

A power source device according to a first exemplary embodiment of the present invention is a power source device including: a plurality of battery cells each including an exterior can formed in a rectangular shape and including opposing main surfaces; insulating heat-shrinkable films covering the plurality of battery cells, respectively; a plurality of separators interposed between the plurality of battery cells; a pair of end plates disposed on both end surfaces of a battery stack formed by stacking the plurality of battery cells with the separators interposed therebetween; and a plurality of bind bars disposed on each of opposing side surfaces of the battery stack and fastening the end plates to each other, wherein the heat-shrinkable films have expandability in which a maximum expansion amount in a heat-shrunk state is larger than a maximum expansion amount of the main surfaces of the exterior can when the battery cells expand.

With the above configuration, in a state where the battery cells are expanded, the heat-shrinkable films have expandability in which the maximum expansion amount in the heat-shrunk state is larger than the maximum expansion amount of the main surfaces of the exterior can at the time of expansion of the battery cells, and thus the heat-shrunk heat-shrinkable films can be effectively prevented from being broken even in a state where the battery cells repeat expansion and contraction.

The power source device according to a second exemplary embodiment of the present invention further includes an adhesive layer between the separator and the heat-shrinkable film facing the separator, and the separator is bonded to the heat-shrinkable film via the adhesive layer.

According to the above configuration, the deformation of the heat-shrinkable film follows the deformation of the battery cells while the separator is fixed at a fixed position of the heat-shrinkable film via the adhesive layer, so that the breakage of the heat-shrinkable film can be prevented to effectively prevent the separator bonded to the heat-shrinkable film from being damaged.

In the power source device according to a third exemplary embodiment of the present invention, an adhesive layer has expandability in which the maximum expansion amount accompanying the deformation of the heat-shrinkable film is larger than the maximum expansion amount of the main surfaces of the exterior can at the time of expansion of the battery cells.

According to the above configuration, since the adhesive layer has expandability in which the maximum expansion amount of the adhesive layer accompanying the deformation of the shrinkable film is larger than the maximum expansion amount of the main surfaces of the exterior can at the time of expansion of the battery cells, the adhesive layer can be prevented from being broken even in a state where the battery cells repeat expansion and contraction, and the deformation of the heat-shrinkable film and the adhesive layer can follow the deformation of the battery cells to effectively prevent the separator from being damaged.

In a power source device according to a fourth exemplary embodiment of the present invention, a separator is disposed on the outer side of a heat-shrinkable film covering a battery cell.

In the power source device described above, it is possible to effectively prevent breakage of the heat-shrinkable film and damage to the separator while disposing the separator on the outer side where a stress at the time of expansion of the battery cell easily acts.

In a power source device according to a fifth exemplary embodiment of the present invention, a separator is made of a hybrid material of an inorganic powder and a fibrous reinforcing material. Furthermore, in a power source device according to a sixth exemplary embodiment of the present invention, the inorganic powder is silica aerogel. In the power source device described above, thermal conductivity of the separator can be reduced to improve heat insulation characteristics.

In a power source device according to a seventh embodiment of the present invention, the heat-shrinkable film is a polyethylene film.

Hereinafter, the present invention will be described in detail with reference to the drawings. Note that, in the following description, terms (e.g., “top”, “bottom”, and other terms including those terms) indicating specific directions or positions are used as necessary; however, the use of those terms is for facilitating the understanding of the invention with reference to the drawings, and the technical scope of the present invention is not limited by the meanings of the terms. Furthermore, parts denoted by the same reference mark in a plurality of drawings indicate an identical or equivalent parts or members.

Further, exemplary embodiments described below show specific examples of the technical idea of the present invention, and the present invention is not limited to the following exemplary embodiments. Unless specifically stated otherwise, dimensions, materials, shapes, relative placement, and the like, of components described below are not intended to limit the scope of the present invention to that alone, and are intended to be illustrative. The contents described in one exemplary embodiment and one working example are also applicable to other exemplary embodiments and working examples. Additionally, sizes, positional relationships, and the like of members illustrated in the drawings may be exaggerated for clarity of description.

### First Exemplary Embodiment

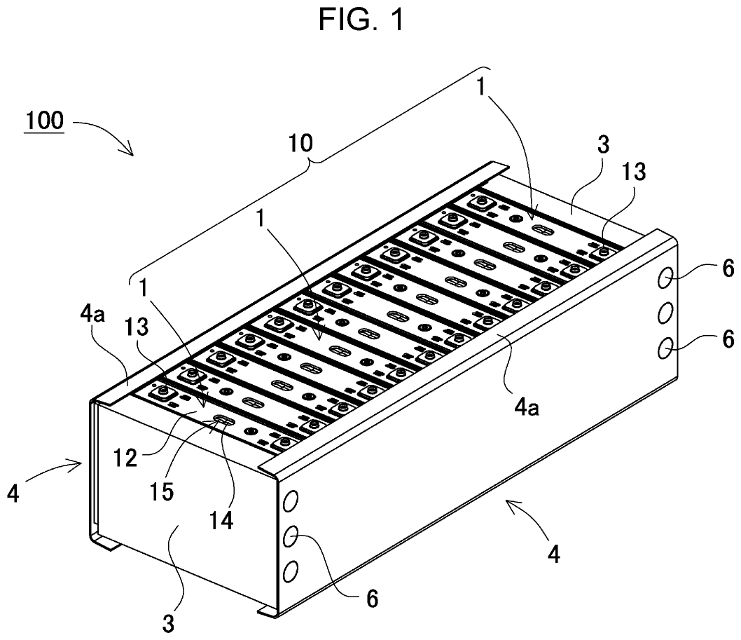

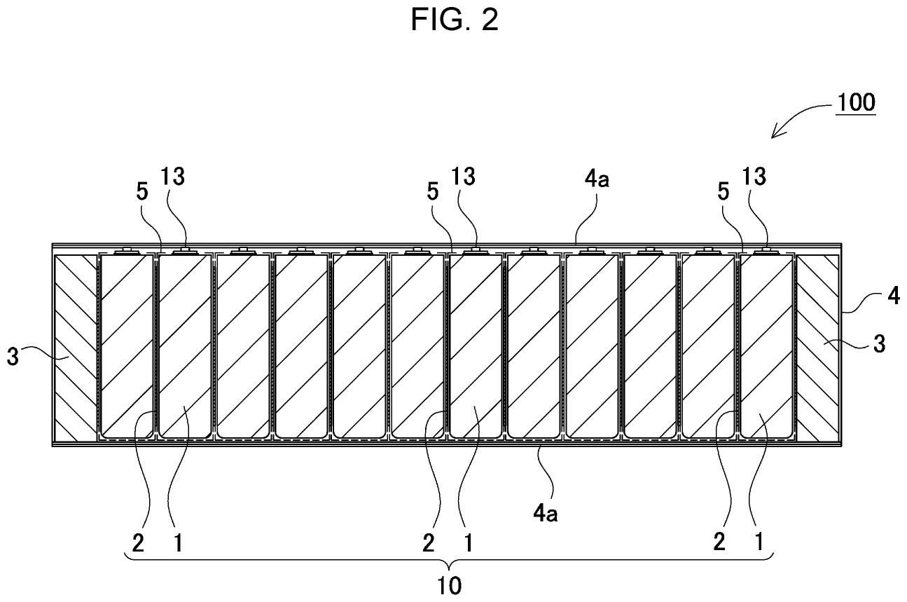

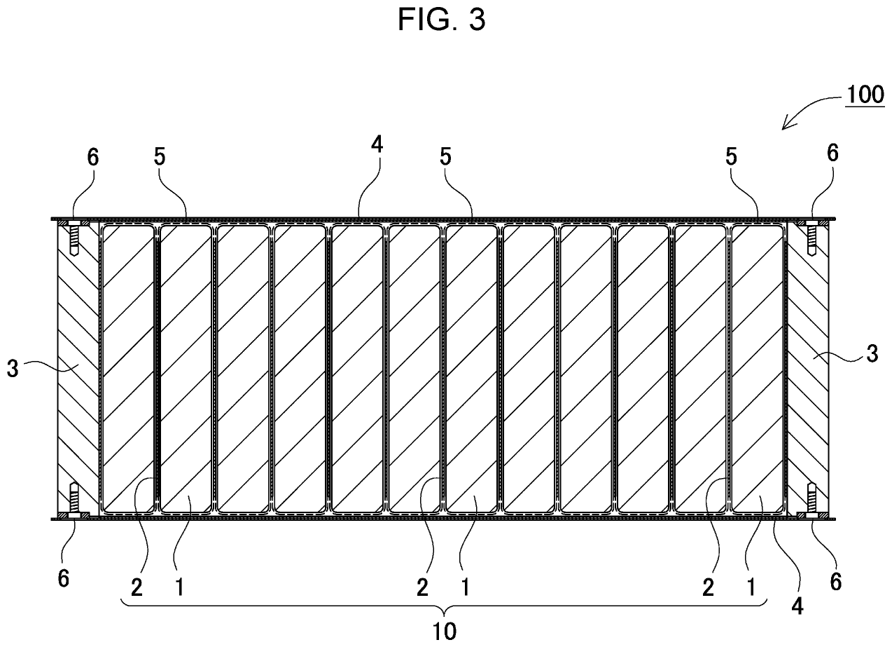

FIG. 1 is a perspective view, FIG. 2 is a vertical sectional view, and FIG. 3 is a horizontal sectional view of power source device 100 according to a first exemplary embodiment of the present invention. Power source device 100 illustrated in these drawings includes a plurality of battery cells 1 each including exterior can 11 formed in a rectangular shape and including opposing main surfaces 1A, insulating films 5 covering the plurality of battery cells 1, respectively, a plurality of separators 2 interposed between the plurality of battery cells 1, a pair of end plates 3 disposed on both end surfaces of battery stack 10 constituted by the plurality of battery cells 1 stacked with separators 2 interposed between battery cells 1, and a plurality of bind bars 4 disposed on each of opposing side surfaces of battery stack 10 and fastening end plates 3 to each other.

(Battery Cell 1)

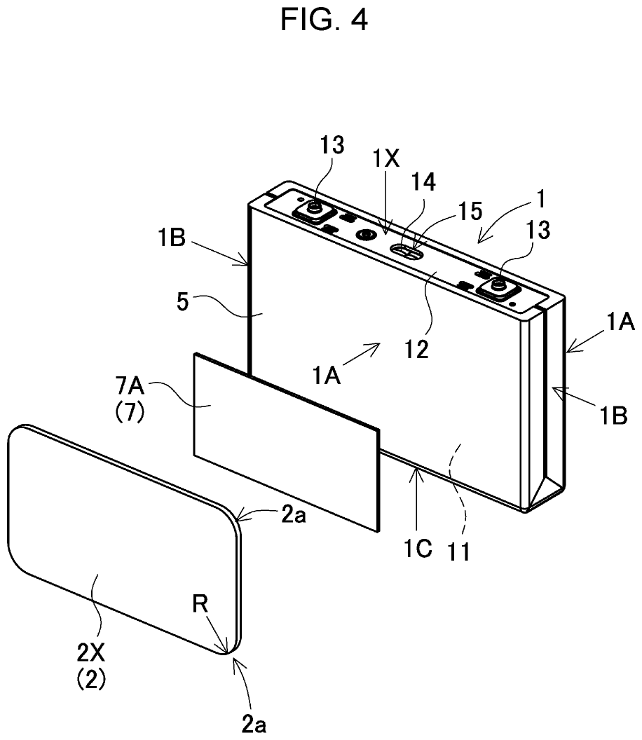

As illustrated in FIG. 4, battery cell 1 is a prismatic battery having main surface 1A that is a wide surface formed in a quadrangular outer shape, and the thickness of the battery cell is smaller than the width of the battery cell. Battery cell 1 is a non-aqueous electrolyte secondary battery such as a lithium-ion secondary battery. Power source device 100 using lithium-ion secondary batteries as battery cells 1 can be made to have a large charging and discharging capacity with respect to volume and weight. However, battery cells 1 are not limited to lithium-ion secondary batteries, and any rechargeable battery such as a nickel-metal-hydride battery can also be used.

Battery cell 1 accommodates an electrode body constituted of stacked positive and negative electrode plates in exterior can 11, and is filled with an electrolyte and airtightly sealed. Exterior can 11 has a rectangular outer shape, has a pair of main surfaces 1A, and is formed in a rectangular cylindrical shape with a closed bottom, and an upper opening is airtightly closed by sealing plate 12 made of a metal sheet. Exterior can 11 is fabricated by deep-drawing a metal sheet of aluminum, aluminum alloy, or the like. Like exterior can 11, sealing plate 12 is fabricated from a metal sheet of aluminum, aluminum alloy, or the like. Sealing plate 12 is inserted in an opening of exterior can 11, and a boundary between an outer periphery of sealing plate 12 and an inner periphery of exterior can 11 is irradiated with a laser beam to fix sealing plate 12 to exterior can 11 in an airtight manner by laser welding.

In battery cell 1, sealing plate 12, which is an upper surface in the drawing, serves as terminal face 1X, and positive and negative electrode terminals 13 are fixed to both end parts of terminal face 1X. Electrode terminal 13 has a protrusion having a circular columnar shape. However, the protrusion is not necessarily required to have a circular columnar shape but may have a polygonal or an elliptic columnar shape. Further, sealing plate 12 is further provided with opening 15 for safety valve 14 between the positive and negative electrode terminals 13. When an internal pressure of battery cell 1 becomes higher than a set value, safety valve 14 opens to release an internal gas, thereby preventing an increase in the internal pressure of battery cell 1 as well as damage to exterior can 11 and sealing plate 12.

### (Heat-Shrinkable Film 5)

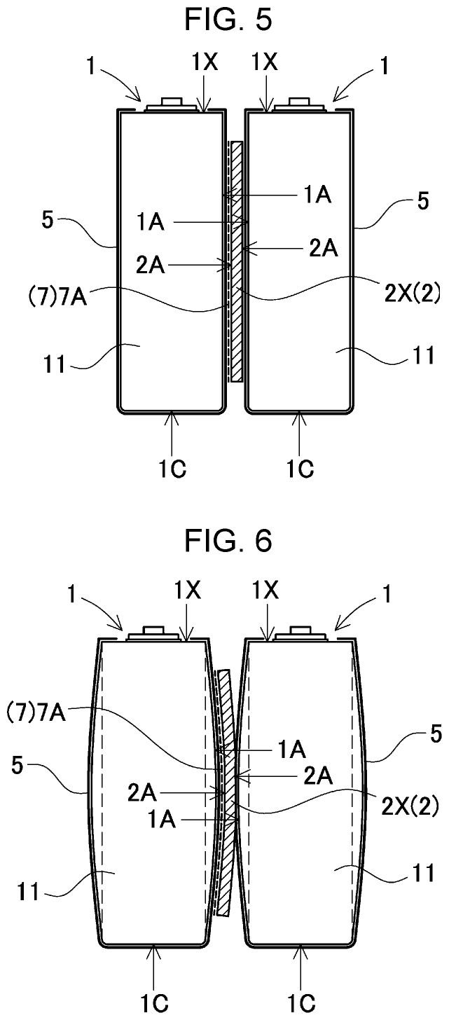

Battery cell 1 illustrated in FIGS. 4 and 5 is insulated by insulating heat-shrinkable film 5 covering an outer peripheral surface of battery cell 1. Heat-shrinkable film 5 covering the periphery of battery cell 1 is heated to thermally shrink, whereby the heat-shrinkable film is tightly fixed to the surface of battery cell 1. Heat-shrinkable film 5 illustrated in FIGS. 4 and 5 covers and insulates surfaces of battery cell 1 except terminal face 1X that is an upper surface of battery cell 1. Specifically, the surfaces of battery cell 1 except the upper surface of battery cell 1 are covered, preferably, main surfaces 1A, side surfaces 1B, and bottom surface 1C are entirely covered. However, the heat-shrinkable film may cover the entire bottom surface, and parts of the main surfaces and the side surfaces except the upper part thereof. The upper surface is not covered with heat-shrinkable film 5 because electrode terminals 13 need to be exposed for electrical connection.

A plastic film having characteristics of shrinking by heat treatment can be used as heat-shrinkable film 5. Further, heat-shrinkable film 5 has expandability in which the maximum expansion amount in the heat shrinkable state is larger than the maximum expansion amount of main surface 1A of exterior can 11 at the time of expansion of battery cell 1. In the present specification, the maximum expansion amount of heat-shrinkable film 5 in the heat-shrunk state is a maximum expansion amount by which heat-shrunk heat-shrinkable film 5 is stretched without being broken, and the maximum expansion amount of main surface 1A of exterior can 11 means a maximum amount by which main surface 1A is stretched when battery cell 1 is expanded. Therefore, heat-shrinkable film 5 has such expandability that the maximum amount of stretch without being broken in the heat-shrunk state is larger than the maximum amount of stretch of main surface 1A when battery cell 1 expands.

A film made of polyethylene terephthalate (PET) is used for a conventional heat-shrinkable film that covers and insulates a prismatic battery cell. The heat-shrinkable film made of PET has been widely used because it is excellent in heat resistance and durability, is inexpensive, and can easily be bonded by thermal welding. However, the heat-shrinkable film made of PET has a disadvantage that expandability is reduced in a heat-shrunk state. In the heat-shrinkable film made of PET, the maximum expansion amount in a heat-shrunk state is equal to or less than the maximum expansion amount of the main surface of the battery cell in which the exterior can is made of aluminum. For this reason, in the heat-shrinkable film made of PET, in a state in which the battery cell repeats expansion and contraction, there is a possibility that the expansion of the heat-shrunk heat-shrinkable film reaches the maximum expansion amount and the film is broken.

Therefore, in the power source device according to the present exemplary embodiment, as heat-shrinkable film 5, a plastic film made of a material having expandability in which the maximum expansion amount in the heat-shrunk state is larger than the maximum expansion amount of main surface 1A of exterior can 11 is used. As such a plastic film, for example, a film made of polyethylene (PE) can be used.

### (Separator 2)

Separator 2 is disposed between battery cells 1 stacked on each other, insulates adjacent battery cells 1 from each other, and further, blocks heat conduction between battery cells 1. Separator 2 is entirely made of hybrid material 2X of an inorganic powder and a fibrous reinforcing material. The inorganic powder is preferably silica aerogel. In hybrid material 2X, fine silica aerogel having a low thermal conductivity is filled in fine gaps between fibers. The silica aerogel is carried and disposed in the gaps in the fibrous reinforcing material. Hybrid material 2X includes a fiber sheet made of a fibrous reinforcing material and silica aerogel having a nano-sized porous structure, and is manufactured by impregnating fibers with a gel raw material of the silica aerogel. After impregnating the fiber sheet with the silica aerogel, the fibers are stacked, reaction of the gel raw material is caused to form wet gel, and the surface of the wet gel is hydrophobized and then dried with hot air to manufacture the hybrid material. The fibers of the fiber sheet are polyethylene terephthalate (PET). Alternatively, inorganic fibers such as flame-retardant oxidized acrylic fibers or glass wool can also be used as fibers of the fiber sheet.

The fibrous reinforcing material preferably has a fiber diameter of 0.1 μm to 30 μm inclusive. The fibrous reinforcing material can improve the heat insulation characteristics of hybrid material 2X by making the fiber diameter smaller than 30 μm and reducing the heat conduction by the fibers. Silica aerogel is inorganic fine particles composed of 90% to 98% of air, and has fine pores between skeletons formed by clusters in which nano-order spherical bodies are bonded, and has a three-dimensional fine porous structure.

Hybrid material 2X of the silica aerogel and the fibrous reinforcing material is thin and has excellent heat insulation characteristics. Considering an energy generated by battery cell 1 that has fallen into thermal runaway, separator 2 made of hybrid material 2X is set to a thickness that can prevent induction of thermal runaway of battery cell 1. The energy generated by the thermal runaway of battery cell 1 increases as the charge capacity of battery cell 1 increases. Therefore, the thickness of separator 2 is set to an optimum value in consideration of the charge capacity of battery cell 1. For example, in a power source device including a lithium ion secondary battery having a charge capacity of 5 Ah to 20 Ah inclusive as battery cell 1, hybrid material 2X has a thickness of 0.5 mm to 3 mm, optimally about 1 mm to 2.5 mm inclusive. However, the present invention does not specify the thickness of hybrid material 2X within the above range. The thickness of hybrid material 2X is set to an optimum value considering the heat insulation characteristics provided by the fiber sheet and the silica aerogel against thermal runaway, and the heat insulation characteristics required for preventing the induction of thermal runaway of the battery cell.

Furthermore, the hardness of separator 2 made of hybrid material 2X can be adjusted by the packing density of the silica aerogel filled in the fibrous reinforcing material. Hybrid material 2X can be made to have a high rigidity by increasing the packing density of the silica aerogel, and a low rigidity by decreasing the packing density of the silica aerogel. To have flexibility, hybrid material 2X used as separator 2 preferably has a low packing density of the silica aerogel to have a low rigidity. As described above, decreasing the rigidity of hybrid material 2X makes separator 2 flexible, and the damage to separator 2 can be avoided or suppressed by following the deformation of battery cell 1 at the time of expansion.

Separator 2 illustrated in FIG. 4 is formed of hybrid material 2X that is shaped along an outer shape of main surface 1A of battery cell 1 to have a quadrangular shape having a size covering a central region of main surface 1A not including an outer peripheral edge part of main surface 1A. However, separator 2 may be sized and shaped to cover the entire main surface, or alternatively, cover a part not including a part of the outer peripheral edge part.

Separator 2 having a quadrangular outer shape as a whole has curved surfaces 2a on four corner portions. As described above, by forming the corner portion with curved surface 2a instead of an angular shape, heat-shrinkable film 5 is prevented from being damaged in a state of being contact with the corner portion. Here, the curvature radius (R) of curved surface 2a provided on the corner portion is preferably larger than the curvature radius of an R face formed on a corner portion of exterior can 11 of battery cell 1. Accordingly, even when the corner portion of the separator is disposed opposite to the corner portion of main surface 1A of battery cell 1, the corner portion of the separator is disposed further in an inner side than the corner portion of the battery cell, so that the stress applied to the heat-shrinkable film can be reduced.

Further, the separator may be provided with a chamfered portion by chamfering an edge portion at an end edge. In this separator, a chambered portion can be provided by chambering a corner portion which is a boundary between an end surface that is an outer peripheral surface, and a stack plane. In the hybrid material containing silica aerogel that is an inorganic powder, when an edge portion of a cut surface becomes sharp at an end edge or the contained inorganic powder is exposed, such a portion or exposed inorganic powder may come into contact with the heat-shrinkable film and cause a breakage. Thus, by chamfering the edge portion of the end edge, the hybrid material can suppress damage when the hybrid material comes into contact with the heat-shrinkable film, and can effectively prevent a breakage of the heat-shrinkable film.

### (Adhesive Layer 7)

Separator 2 described above is bonded via adhesive layer 7 to main surface 1A of battery cell 1 covered with heat-shrinkable film 5. Adhesive layer 7 is a member for bonding separator 2 to heat-shrinkable film 5 tightly attached to the surface of battery cell 1. An adhesive or a bonding agent can be used as adhesive layer 7. That is, in the present specification, the term “bonding” has a broad meaning including sticking.

A member having higher expandability than separator 2 is used for adhesive layer 7. Preferably, adhesive layer 7 having expandability in which the maximum expansion amount accompanying the deformation of heat-shrinkable film 5 is larger than the maximum expansion amount of main surface 1A of exterior can 11 at the time of expansion of battery cell 1 is used. As described above, since adhesive layer 7 has expandability in which the maximum expansion amount is larger than the maximum expansion amount of main surface 1A, it is possible to prevent adhesive layer 7 from being broken even in a state where battery cell 1 repeats expansion and contraction. Since both heat-shrinkable film 5 and adhesive layer 7 can follow the deformation of battery cell 1, it is possible to effectively prevent separator 2 fixed to heat-shrinkable film 5 from being damaged.

A urethane-based or silicon-based adhesive can be used for adhesive layer 7. FIG. 4 illustrates a state in which separator 2 is bonded to main surface 1A of battery cell 1 via double-sided tape 7A as adhesive layer 7. As double-sided tape 7A, a double-sided tape in which the above-described adhesive or bonding agent is applied to both surfaces of a base material sheet can be used.

### (Battery Stack 10)

The plurality of battery cells 1 each covered with heat-shrinkable film 5 are stacked such that separator 2 is interposed between adjacent battery cells 1 to form battery stack 10. As illustrated in FIG. 5, separator 2 sandwiched between adjacent battery cells 1 is stacked such that one of stack planes 2A is bonded to heat-shrinkable film 5 covering battery cell 1 via adhesive layer 7 and the other of stack planes 2A is in surface contact with heat-shrinkable film 5 covering battery cell 1, whereby battery stack 10 is formed.

As described above, in battery stack 10 in which the plurality of battery cells 1 and separator 2 are stacked, as illustrated in FIG. 6, when battery cells 1 are expanded, main surface 1A is expanded and stretched in a stacking direction of battery cells 1, but since heat-shrinkable film 5 has expandability in which the maximum expansion amount of heat-shrunk heat-shrinkable film 5 is larger than the maximum expansion amount of main surface 1A, the heat-shrinkable film is held in a stretched state without being broken. Therefore, the stress in a breaking direction received from heat-shrinkable film 5 is also reduced in separator 2 bonded to heat-shrinkable film 5 that is not broken, and separator 2 is held in a state of not being damaged such as breaking. In particular, by using, as adhesive layer 7, one having expandability in which the maximum expansion amount accompanying the deformation of heat-shrinkable film 5 is larger than the maximum expansion amount of main surface 1A, the stress acting on separator 2 in the breaking direction is further relaxed, and damage such as breaking can be more reliably prevented.

In battery stack 10, the plurality of battery cells 1 are stacked such that terminal faces 1X provided with positive and negative electrode terminals 13, or sealing plates 12 in FIG. 1, are flush with each other. In battery stack 10, a metal bus bar (not shown) is connected to positive and negative electrode terminals 13 of adjacent battery cells 1, and the plurality of battery cells 1 are connected in series or in parallel, or in series and parallel by the bus bars. The battery cells connected in series are insulated by a separator interposed between the battery cells because a potential difference is generated between the exterior cans. The battery cells connected in parallel do not generate a potential difference between the exterior cans, but are heat-insulated by a separator interposed between the battery cells in order to prevent induction of thermal runaway. In battery stack 10 illustrated in the drawing, 12 battery cells 1 are connected in series. However, the present invention does not limit the number and the state of connection of battery cells 1 constituting battery stack 10.

### (End Plate 3)

As illustrated in FIGS. 1 to 3, end plates 3 are disposed at both ends of battery stack 10, sandwiching battery stack 10 from both ends. End plate 3 has a quadrangular shape having substantially the same shape and dimensions as those of the outer shape of battery cell 1, and is entirely made of metal. Metal end plates 3 can achieve excellent strength and durability. A pair of end plates 3 disposed at both ends of battery stack 10 are fastened via a plurality of bind bars 4 disposed along both side surfaces of battery stack 10.

### (Bind Bar 4)

Bind bars 4 are disposed on both opposite side surfaces of battery stack 10 to fasten the pair of end plates 3 disposed on both end surfaces of battery stack 10. As illustrated in FIGS. 1 and 2, bind bars 4 extend in the stacking direction of battery stack 10, and fix the pair of end plates 3 at a predetermined distance therebetween to fix battery cells 1 stacked between end plates 3 in a predetermined compressed state. Bind bar 4 is a metal sheet having a predetermined width and a predetermined thickness and disposed along a side surface of battery stack 10. A metal sheet that withstands a high tensile force is used as bind bar 4. Bind bar 4 in the drawing is a metal sheet having a vertical width and covering a side surface of battery stack 10. Bind bar 4 made of a metal sheet is bent by press molding or the like to be formed into a predetermined shape. Upper and lower end edge portions of bind bar 4 illustrated in the drawing are bent by processing to form bent portions 4a. Upper and lower bent portions 4a located at the right and left side surfaces of battery stack 10 are shaped to cover upper and lower surfaces of battery stack 10 from corner portions of battery stack 10. Bind bars 4 illustrated in the drawing are fixed to both side surfaces of end plates 3 via a plurality of fixing pins 6.

The power source device described above can be used as an automotive power source that supplies electric power to a motor used to cause an electric vehicle to travel. As an electric vehicle on which the power source device is mounted, an electric vehicle such as a hybrid car or a plug-in hybrid car that travels by both an engine and a motor, or an electric car that travels only by a motor can be used, and the power source device is used as a power source for the vehicle. Note that, in order to obtain electric power for driving a vehicle, an example of constructing a large-capacity and high-output power source device 100 will be described below in which a large number of the above-described power source devices are connected in series or in parallel, and a necessary controlling circuit is further added.

### (Power Source Device for Hybrid Vehicle)

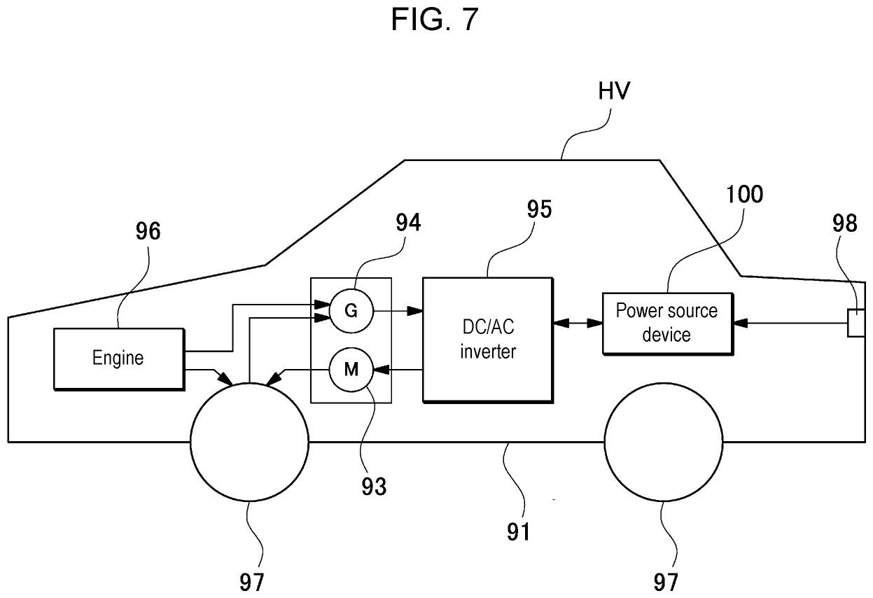

FIG. 7 illustrates an example of a power source device mounted on a hybrid car that travels by both an engine and a motor. Vehicle HV on which the power source device illustrated in this drawing is mounted includes vehicle body 91, engine 96 and travel motor 93 that cause vehicle body 91 to travel, wheels 97 that are driven by engine 96 and travel motor 93, power source device 100 that supplies electric power to motor 93, and power generator 94 that charges batteries of power source device 100. Power source device 100 is connected to motor 93 and power generator 94 via DC/AC inverter 95. Vehicle HV travels by both motor 93 and engine 96 while charging and discharging the batteries of power source device 100. Motor 93 is driven in a region where an engine efficiency is low, for example, during acceleration or low-speed traveling, and causes the vehicle to travel. Motor 93 is driven by electric power supplied from power source device 100. Power generator 94 is driven by engine 96 or regenerative braking when the vehicle is braked to charge the batteries of power source device 100. As illustrated in FIG. 7, vehicle HV may include charging plug 98 to charge power source device 100. Connecting charging plug 98 to an external power source enables charging power source device 100.

### (Power Source Device for Electric Vehicle)

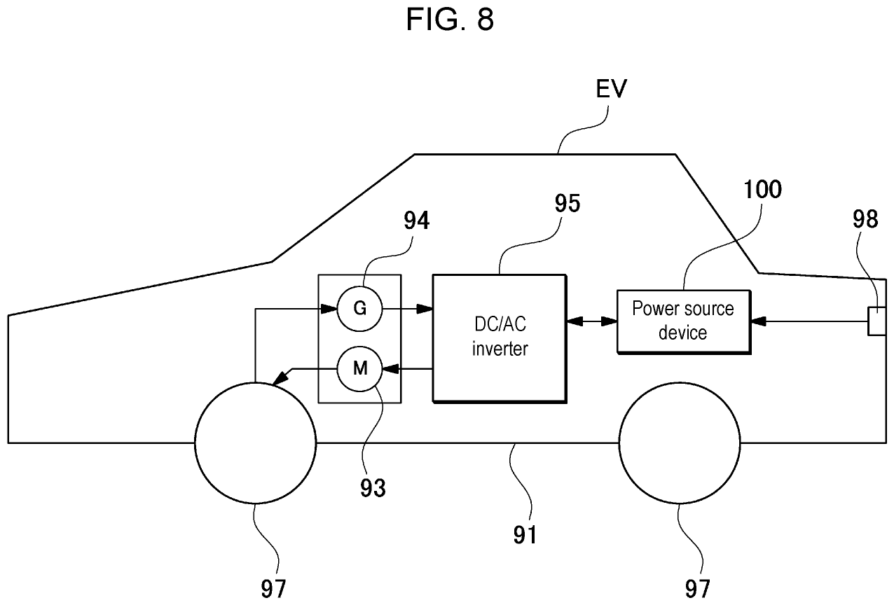

FIG. 8 illustrates an example of a power source device mounted on an electric car that travels only by a motor. Vehicle EV on which the power source device illustrated in this figure is mounted includes vehicle body 91, travel motor 93 that causes vehicle body 91 to travel, wheels 97 that are driven by motor 93, power source device 100 that supplies electric power to motor 93, and power generator 94 that charges batteries of power source device 100. Power source device 100 is connected to motor 93 and power generator 94 via DC/AC inverter 95. Motor 93 is driven by electric power supplied from power source device 100. Power generator 94 is driven by energy at the time of regenerative braking of vehicle EV to charge the batteries of power source device 100. Furthermore, vehicle EV includes charging plug 98, and connecting charging plug 98 to an external power source enables charging power source device 100.

### (Power Source Device for Power Storage Device)

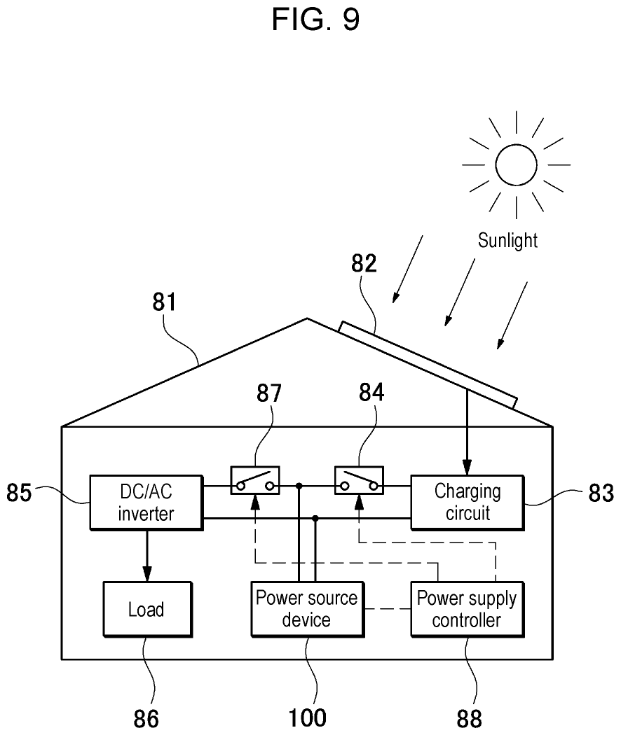

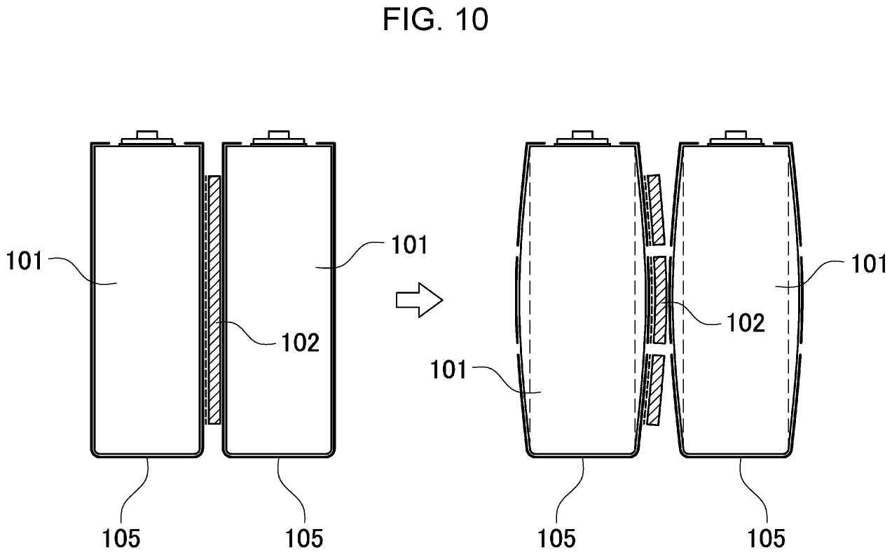

Further, the present invention does not limit an application of the power source device to a power source of a motor that causes a vehicle to travel. The power source device according to the exemplary embodiment can also be used as a power source for a power storage device that stores electricity by charging a battery with electric power generated by photovoltaic power generation, wind power generation, or the like. FIG. 9 illustrates a power storage device that stores electricity by charging batteries of power source device 100 with solar cell 82.

The power storage device illustrated in FIG. 9 charges the batteries of power source device 100 with electric power generated by solar cell 82 that is disposed, for example, on a roof or a rooftop of building 81 such as a house or a factory. The power storage device charges the batteries of power source device 100 through charging circuit 83 with solar cell 82 serving as a charging power source, and then supplies electric power to load 86 via DC/AC inverter 85. Thus, the power storage device has a charge mode and a discharge mode. In the power storage device illustrated in the drawing, DC/AC inverter 85 and charging circuit 83 are connected to power source device 100 via discharging switch 87 and charging switch 84, respectively. Discharging switch 87 and charging switch 84 are turned on and off by power supply controller 88 of the power storage device. In the charge mode, power supply controller 88 turns on charging switch 84 and turns off discharging switch 87 to allow charging from charging circuit 83 to power source device 100. Furthermore, when charging is completed and the batteries are fully charged or in a state where a capacity equal to or larger than a predetermined value is charged, power supply controller 88 turns off charging switch 84 and turns on discharging switch 87 to switch to the discharge mode, and allow discharging from power source device 100 to load 86. Further, when needed, the power supply controller can supply electric power to load 86 and charge power source device 100 simultaneously by turning charging switch 84 and discharging switch 87 on.

Although not illustrated, the power source device can also be used as a power source of a power storage device that stores electricity by charging a battery using midnight electric power at night. The power source device charged with the midnight electric power can limit peak electric power during the daytime to a small value by charging with the midnight electric power that is surplus electric power of the power plant, and by outputting the electric power during the daytime when an electric power load increases. Further, the power source device can also be used as a power source that is charged with both output power of a solar cell and the midnight electric power. This power source device can efficiently store electricity using both electric power generated by the solar cell and the midnight electric power in consideration of weather and electric power consumption.

The power storage device described above can be suitably used for the following applications: a backup power source device mountable in a rack of a computer server; a backup power source device used for radio base stations of cellular phones; a power source for power storage used at home or in a factory; a power storage device combined with a solar cell, such as a power source for street lights; and a backup power source for traffic lights or traffic displays for roads.

### INDUSTRIAL APPLICABILITY

The power source device according to the present invention is suitably used as a power source for a large current used for a power source of a motor for driving an electric vehicle such as a hybrid car, a fuel cell car, an electric car, or an electric motorcycle. Examples of the power source device include a power source device for a plug-in hybrid electric car and a hybrid electric car capable of switching a traveling mode between an EV traveling mode and an HEV traveling mode, and a power source device for an electric car. Furthermore, the power source device can also be appropriately used for the following applications: a backup power source device mountable in a rack of a computer server; a backup power source device used for radio base stations of cellular phones; a power source for power storage used at home or in a factory; a power storage device combined with a solar cell, such as a power source for street lights; and a backup power source for traffic lights.

### REFERENCE MARKS IN THE DRAWINGS

100: power source device
1: battery cell
1X: terminal face
1A: main surface
1B: side surface
1C: bottom surface
2: separator
2X: hybrid material
2A: stack plane
2a: curved surface
3: end plate
4: bind bar
4a: bent portion
5: heat-shrinkable film
6: fixing pin
7: adhesive layer
7A: double-sided tape
10: battery stack
11: exterior can
12: sealing plate
13: electrode terminal
14: safety valve
15: opening
81: building
82: solar cell
83: charging circuit
84: charging switch
85: DC/AC inverter
86: load
87: discharging switch
88: power supply controller
91: vehicle body
93: motor
94: power generator
95: DC/AC inverter
96: engine
97: wheel
98: charging plug
HV, EV: vehicle
101: battery cell
102: separator
105: heat-shrinkable film

1. A power source device comprising:
a plurality of battery cells each including an exterior can in a prism shape, the exterior can including main surfaces opposing each other;
an insulating heat-shrinkable film covering a corresponding one of the plurality of battery cells;
a plurality of separators each being interposed between a corresponding pair of adjacent battery cells among the plurality of battery cells;
a battery stack including the plurality of battery cells being stacked together with the separators;
a pair of end plates disposed on both end surfaces of the battery stack; and
a plurality of bind bars each being disposed on a corresponding one of opposing side surfaces of the battery stack and fastening the end plates to each other,
wherein a maximum expansion amount of the insulating heat-shrinkable film shrunk by heat is larger than a maximum expansion amount of the main surfaces of the exterior can when the battery cells expand.

2. The power source device according to claim 1, further comprising an adhesive layer disposed between each of the plurality of separators and an insulating heat-shrinkable film of a battery cell adjacent to a corresponding separator among the separators,
wherein the corresponding separator is bonded to the insulating heat-shrinkable film via the adhesive layer.

3. The power source device according to claim 2, wherein
a maximum expansion amount of the adhesive layer when the insulating heat-shrinkable film is deformed is larger than a maximum expansion amount of the main surfaces of the exterior can when the battery cell is expanded.

4. The power source device according to claim 1, wherein
each of the separators is disposed outside the insulating heat-shrinkable film covering each of the adjacent battery cells.

5. The power source device according to claim 1, wherein
the separators includes a hybrid material of an inorganic powder and a fibrous reinforcing material.

6. The power source device according to claim 5, wherein
the inorganic powder is silica aerogel.

7. The power source device according to claim 1, wherein
the insulating heat-shrinkable film is a polyethylene film.

8. An electric vehicle including the power source device according to claim 1, the electric vehicle comprising:
the power source device;
a motor for travelling that receives electric power from the power source device;
a vehicle body that incorporates the power source device and the motor; and
wheels driven by the motor to cause the vehicle body to travel.

9. A power storage device including the power source device according to claim 1, the power storage device comprising:
the power source device; and
a power supply controller that controls charging and discharging of the power source device,
wherein the power supply controller enables charging of the secondary battery cell with electric power supplied from an outside, and performs control to charge the secondary battery cell.
